(19) United States
(12) Patent Application Publication
(10) Pub. No.: US 2007/0054108 A1
(43) Pub. Date: Mar. 8, 2007

(54) Thermal interface material and apparatus and method for fabricating the same

(75) Inventor: Shih-Chieh Yen, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/398,017

(22) Filed: Apr. 4, 2006

(30) Foreign Application Priority Data
Sep. 6, 2005 (CN) 200510037125.2

(51) Int. Cl. B05D 1/12; B32B 3/00; B32B 27/00

(52) U.S. Cl. 428/312.2; 427/180; 428/312.8; 428/319.3

(57) ABSTRACT

The present invention discloses a thermal interface material. The thermal interface material (20) includes a number of thermally conductive particles (22), the majority of the thermally conductive particles (22) being brought into contact with each other, thereby forming a thermally conductive network (23); and a polymer material (21) filled in interspaces of the thermally conductive particles (22). The present invention also discloses an apparatus and a method for fabricating the thermal interface material. The thermal interface material of the present invention includes thermally conductive particles (22), which are in contact with each other to form a continuous thermally conducting network (23); thus the heat can be transferred continuously, the high resistance between the thermally conductive particles (22) caused by the polymer material (21) is reduced, and the thermal interface material can thus obtain low thermal resistance and excellent thermal conductivity.

### BACKGROUND

1. Field of the Invention

The present invention relates generally to thermal interface materials. More particularly, the present invention relates to a thermal interface material having improved thermal conductivity, and an apparatus and a method for fabricating the same.

2. Discussion of Related Art

Electronic components such as semiconductor chips are constantly being developed to be more compact and to run faster, this means that modern chips produce much more heat and thus require better heat dissipation. Commonly, a thermal interface material is utilized between the electronic component and a heat sink in order to dissipate heat generated by the electronic component.

A conventional thermal interface material is obtained by diffusing particles with a high thermal conductivity in a matrix material. The particles can be graphite, boron nitride, silicon oxide, alumina, silver, or other metals. However, the thermal conductivity of the thermal interface material obtained by such a process is usually unsatisfactory for many contemporary applications.

Referring to FIG. 1, there is shown a typical thermal interface material 10, made by directly dispersing filler particles 12 which have excellent thermal conductivity, into a polymer matrix 11. As such, most of the particles 12 are isolated from each other by the polymer matrix 11. Therefore, contact between the particles 12 is fairly small. Consequently, thermally conductive paths constructed by the particles in contact are relatively short and inadequate, thus causing a high thermal resistance in the thermal interface material.

Therefore, what is needed is to provide a thermal interface material which has excellent thermal conductivity, and an apparatus and a method for fabricating the same.

### SUMMARY

In one aspect of the present invention, a thermal interface material is provided. The thermal interface material includes a number of thermally conductive particles, the majority of the thermally conductive particles being brought into contact with each other, thereby forming a thermally conductive network; and a polymer material filled in interspaces of the thermally conductive particles.

In another aspect of the present invention, an apparatus for making the thermal interface material is provided. The apparatus includes an upper molding part having an upper molding portion; a lower molding part having a lower molding portion, the lower molding part being disposed in manner such that the lower molding portion faces the upper molding portion. A guiding block is also included defining a guiding channel configured for receiving the upper molding portion and the lower molding portion therein. A cavity is defined by the guiding block, the upper molding portion, and the lower molding portion cooperatively. An upper heating member is disposed on the upper molding part; and a lower heating member is disposed below the lower molding part. Wherein the upper molding part defines a sprue therethrough for introducing a liquid polymer material in the cavity, and the upper and lower heating members are configured for heating the liquid polymer material thereby keeping the liquid polymer material in a liquid state.

In still another aspect of the present invention, a method for making the thermal interface material is provided. The method includes the following steps: providing a number of thermally conductive particles; pressing the thermally conductive particles so as to enable the majority of the thermally conductive particles to come into contact with each other; filling a liquid polymer material into interspaces of the thermally conductive particles thereby forming a mixture; and hardening the mixture thereby forming the thermal interface material.

Unlike a conventional thermal interface material, the thermal interface material of the present invention includes thermally conductive particles, which are in contact with each other to form a continuous thermally conducting network; thus the heat can be transferred continuously, the high resistance between the thermally conductive particles caused by the polymer material is reduced, and the thermal interface material can thus display low thermal resistance and excellent thermal conductivity.

### BRIEF DESCRIPTION OF THE DRAWINGS

The above-mentioned and other features and advantages of thermal interface material, and the manner of attaining them, will become more apparent and the invention will be better understood by reference to the following description of embodiments thereof taken in conjunction with the accompanying drawings.

FIG. 1 is a schematic view of a conventional thermal interface material.

FIG. 2 is a schematic view of a thermal interface material according to an exemplary embodiment of the present invention.

FIG. 3 is a schematic view of an apparatus for fabricating the thermal interface material according to an aspect of the present invention.

FIG. 4 is a flow chart of a method for fabricating the thermal interface material according to another aspect of the present invention.

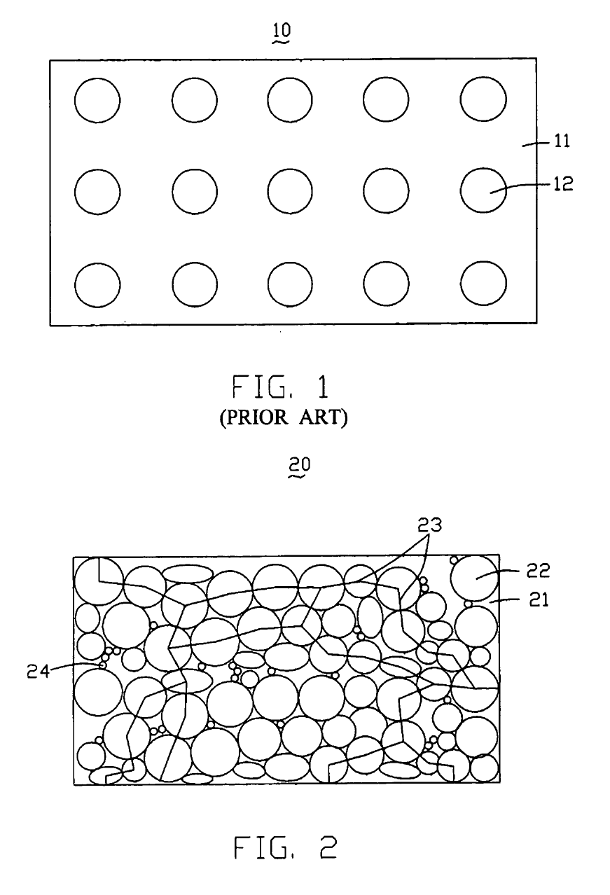

Corresponding reference characters indicate corresponding parts throughout the several views. The exemplifications set out herein illustrate at least one preferred embodiment of the invention, in one form, and such exemplifications are not to be construed as limiting the scope of the invention in any manner.

### DETAILED DESCRIPTION OF THE EMBODIMENTS

Reference will now be made to the drawings to describe in detail the preferred embodiments of the present thermal interface material, and apparatus and method for fabricating the same.

Referring to FIG. 2, a thermal interface material 20 according to an exemplary embodiment of the present invention is shown. The thermal interface material 20 includes a number of thermally conductive particles 22, and a polymer material 21 filled in the interspaces between thermally conductive particles 22. The majority of the thermally conductive particles 22 are brought into contact with each other. Such contact enables direct heat exchanges therebetween, thus constructing continuous thermally conductive paths, as a whole forming a thermally conductive network 23.

The thermally conductive particles 22 can be made of silver, alumina, zinc oxide, silicon oxide, titanium oxide, aluminum nitride, boron nitride, silicon carbide, aluminum carbide, and/or any appropriate combination of these compounds. An average size of the thermally conductive particles 22 is in the range from 10 to 50 microns. The polymer material 21 can be made of silicone rubber, polyester, polyvinyl chloride, polyvinyl alcohol, polyethylene, polypropylene, epoxy resin, polycarbonate, polyoxymethylene and/or any appropriate combination of these compounds.

Alternatively, a plurality of carbon particles 24 with smaller size and higher thermal conductivity could be employed to fill the interspaces between the thermally conductive particles 22, for making the thermally conductive network 23 denser. An average size of the carbon particles 24 is smaller than 10 microns.

In use, because the thermally conductive particles 22 are in contact with each other to form a continuous thermally conductive network 23, the heat can be conducted continuously along the thermally conductive paths of the conducting network 23. As such, the thermal interface material 20 is capable of dissipating heat efficiently and thus obtaining excellent thermal conductivity.

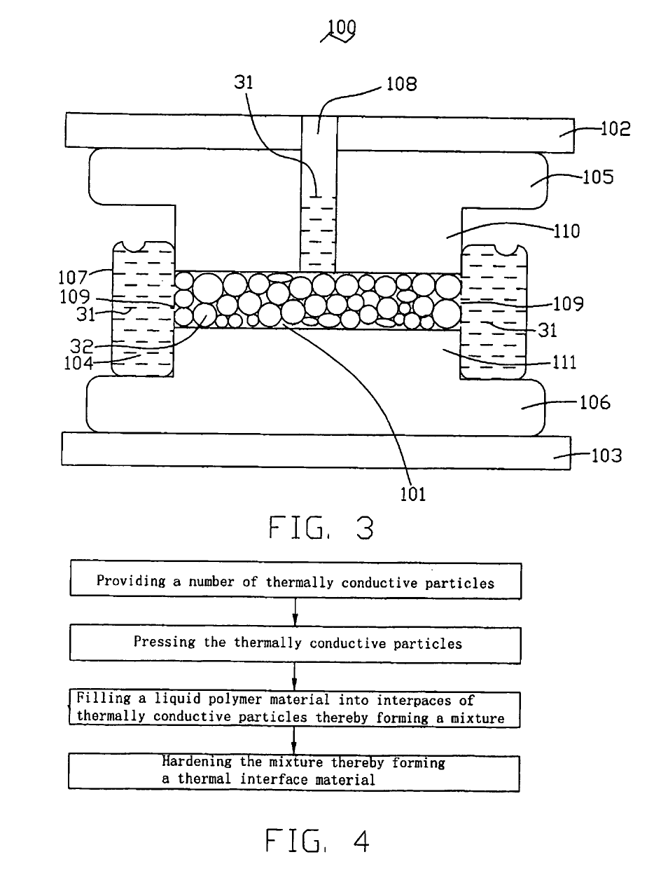

Referring to FIG. 3, there are shown a schematic view of an apparatus 100 for fabricating the thermal interface material. The apparatus 100 includes: a cavity 101, an upper heating member 102, a lower heating member 103, an upper molding part 105 having an upper molding portion 110, a lower molding part 106 having a lower molding portion 111, a guiding block 107 defining a guiding channel, and a sprue 108. The upper molding part 105 is over the lower molding part 106, and the upper molding portion 110 faces the lower molding portion 111. The guiding channel defined by the guiding block 107 receives the upper molding portion 110 and the lower molding portion 111 therein. The cavity 101 is defined by the guiding block 107, the upper molding portion 110, and the lower molding portion 111 cooperatively. In addition, the upper heating member 102 is disposed on the upper molding part 105. The lower heating member 103 is disposed below the lower molding part 106. The sprue 108 penetrates through the upper heating member 102 and upper molding part 105 to the cavity 101.

In use, the cavity 101 is adapted to contain the thermally conductive particles 32 and a polymer material 31. The upper heating member 102 and the lower heating member 103 are used to keep the polymer material 32 in a liquid state, while also mixing the thermally conductive particles 32 and polymer material 31. The upper molding part 105 and the lower molding part 106 are also used to press the thermally conductive particles 32 thereon. In addition, the sprue 108 is used for introducing the liquid polymer material 31 into the cavity 1.

Alternatively, the guiding block 107 could include a number of holes 109 in communication with the cavity 101, and a chamber 104 in communication with the holes 109. The holes 109 and the chamber 104 are respectively adapted to first outflow and then contain superfluous liquid polymer material 31.

Referring to FIG. 3, there is shown a flow chart of a method for fabricating the thermally interface material. The method is to be illustrated in detail below.

Firstly, a number of thermally conductive particles 32 is provided. The thermally conductive particles 32 may be made of silver, alumina, zinc oxide, silicon oxide, titanium oxide, aluminum nitride, boron nitride, silicon carbide, aluminum carbide, carbon and/or any appropriate combination of these compounds.

Secondly, the thermally conductive particles 32 is pressed so as to enable the majority of the thermally conductive particles 32 to come into contact with each other in the cavity 101. Pressing is performed on the upper molding part 105 or the lower lower molding part 106, and the pressure is in the range from 30 to 50 N/m².

Thirdly, a liquid polymer material 31 is filled into the interspaces of thermally conductive particles 32, thereby forming a mixture. The liquid polymer material 31 is introduced through the sprue 108 at room temperature; and the superfluous liquid polymer material 31 can outflow from the holes 109 into the chamber 104. The polymer material 31 may be made of silicone rubber, polyester, polyvinyl chloride, polyvinyl alcohol, polyethylene, polypropylene, epoxy resin, polycarbonate, polyoxymethylene, and/or any appropriate combination of these compounds. It is to be understood that if the polymer material 31 is not liquid at room temperature, it can be heated to liquefy beforehand.

In this third step, the thermally conductive particles 32 and the liquid polymer material 31 are mixed by gravity and capillary action for some time, such as tens of minutes to an hour. Also, to keep the polymer material 31 in a liquid state, the upper heating member 102, the lower heating member 103 and the thermally conductive particles 32 can be heated up beforehand; also the upper heating member 102 and the lower heating member 103 could alternatively be kept hot while mixing. The heating temperature is in the range from 100 to 350 degrees centigrade.

Finally, the mixture is hardened, thereby forming a thermal interface material. Harding is performed by cooling, and the time period of hardening is from one hour to six hours; in the preferred embodiment, the time period is about 3 hours.

While the present invention has been described as having preferred or exemplary embodiments, the embodiments can be further modified within the spirit and scope of this disclosure. This application is therefore intended to cover any variations, uses, or adaptations of the embodiments using the general principles of the invention as claimed. Furthermore, this application is intended to cover such departures from the present disclosure as come within known or customary practice in the art to which the invention pertains and which fall within the limits of the appended claims or equivalents thereof.

What is claimed is:

1. A thermal interface material comprising:
a plurality of thermally conductive particles, the majority of the thermally conductive particles being brought into contact with each other, thereby forming a thermally conductive network; and
a polymer material filled in interspaces of the thermally conductive particles.

2. The thermal interface material as described in claim 1, wherein the thermally conductive particles are comprised of a material selected from the group consisting of silver, alumina, zinc oxide, silicon oxide, titanium oxide, aluminum nitride, boron nitride, silicon carbide, aluminum carbide, and any combination of these compounds.

3. The thermal interface material as described in claim 2, wherein an average size of the thermally conductive particles is in the range from 10 to 50 microns.

4. The thermal interface material as described in claim 1, further comprising a plurality of carbon particles filled the interspaces of the thermally conductive particles.

5. The thermal interface material as described in claim 4, wherein an average size of the carbon particles is smaller than 10 microns.

6. The thermal interface material as described in claim 1, wherein the polymer material is selected from the group consisting of silicone rubber, polyester, polyvinyl chloride, polyvinyl alcohol, polyethylene, polypropylene, epoxy resin, polycarbonate, polyoxymethylene, and any combination of these compounds.

7. An apparatus for fabricating a thermal interface material, comprising:
an upper molding part having an upper molding portion;
a lower molding part having a lower molding portion; the lower molding part being disposed in manner such that the lower molding portion faces the upper molding portion; and
a guiding block defining a guiding channel configured for receiving the upper molding portion and the lower molding portion therein; the guiding block, the upper molding portion, and the lower molding portion cooperatively defining a cavity for receiving a plurality of thermal conductive particles therein;
an upper heating member disposed on the upper molding part; and
a lower heating member disposed below the lower molding part; wherein
the upper molding part defines a sprue therethrough for introducing a liquid polymer material in the cavity, the upper and lower heating members configured for heating the liquid polymer material thereby maintaining the liquid polymer material in a liquid state.

8. The apparatus as described in claim 7, wherein the guiding block further comprises a plurality of holes in communication with the cavity.

9. The apparatus as described in claim 8, wherein, the guiding plate further comprises a chamber in communication with the cavity via the holes.

10. A method for fabricating a thermal interface material, the method comprising the steps of:
providing a plurality of thermally conductive particles;
pressing the thermally conductive particles so as to enable the majority of the thermally conductive particles to come into contact with each other;
filling a liquid polymer material into interspaces of the thermally conductive particles thereby forming a mixture; and
hardening the mixture thereby forming the thermally interface material.

11. The method as described in claim 10, wherein the thermally conductive particles are comprised of a material selected from the group consisting of silver, alumina, zinc oxide, silicon oxide, titanium oxide, aluminum nitride, boron nitride, silicon carbide, aluminum carbide, carbon, and any combination of these compounds.

12. The method as described in claim 10, wherein the polymer material is selected from the group consisting of silicone rubber, polyester, polyvinyl chloride, polyvinyl alcohol, polyethylene, polypropylene, epoxy resin, polycarbonate, polyoxymethylene, and any combination of these compounds.

13. The method as described in claim 10, wherein the step of pressing is performed under a pressure in the range from 30 to 50 N/m².

14. The method as described in claim 10, wherein the step of hardening is performed for a time period of one hour to six hours.

15. The method as described in claim 13, wherein the time period of the step of hardening is about three hours.
